(19) United States
(12) Patent Application Publication
(10) Pub. No.: US 2014/0358298 A1
(43) Pub. Date: Dec. 4, 2014

(54) ALIGNMENT TOOL

(71) Applicant: DWFritz Automation, Inc., Wilsonville, OR (US)

(72) Inventors: Ryan S. Hall, Keizer, OR (US); Joshua Victor Aller, Portland, OR (US)

(73) Assignee: DWFritz Automation, Inc., Wilsonville, OR (US)

(21) Appl. No.: 14/244,395

(22) Filed: Apr. 3, 2014

Related U.S. Application Data
(60) Provisional application No. 61/829,377, filed on May 31, 2013.

(51) Int. Cl. G01B 11/26

(52) U.S. Cl. CPC G01B 11/26
USPC 700/279

(57) ABSTRACT

In embodiments, one or more targets, each comprising one or more dots, may be permanently or removably affixed to one or more components of a mechanical system such as a bicycle. A computing device may capture a two-dimensional image of the one or more targets. The two-dimensional image may be processed and the location of the targets in three-dimensional space may be determined based at least in part on the processing. Based at least in part on the location of the targets in three-dimensional space, one or more adjustments to one or more of the components of the mechanical system may be identified, and instructions related to those adjustments may be provided to the user. In embodiments, the computing device may be a smartphone. In embodiments, the one or more components may be one or more of a bicycle frame, derailleur, and/or cassette.

### CROSS REFERENCE TO RELATED APPLICATION

The present application claims priority to U.S. Provisional Patent Application No. 61/829,377, filed May 31, 2013, entitled “Bike Alignment Tool,” the entire disclosure of which is hereby incorporated by reference in its entirety.

### TECHNICAL FIELD

Embodiments herein relate to a tool for aligning one or more components of a mechanical system such as a bicycle.

### BACKGROUND

Modern mechanical systems such as bicycles may use multiple gears, and require one or more components such as an indexing shifter. In general, the shifter may require very precise adjustment in order to shift a chain such as a bicycle chain to each gear in a rear cassette. Generally, the shifting is accomplished via a derailleur coupled with the shifter. When the shifter is activated, the derailleur may move slightly which alters the position of the bicycle chain with respect to the cassette. This movement may cause the bicycle chain to move to a different gear on the cassette.

Calibrating and adjusting the shifter and derailleur may be desired for a variety of reasons such as component wear, damage to the bicycle frame, shifter, or derailleur, or changing to a new cassette and/or wheel. However, in many cases, precisely calibrating and adjusting a shifter and derailleur may require extensive trial and error by a person with little calibration experience, or paying a person with more calibration experience to adjust the components. In either case, extensive time and/or financial resources may be spent to precisely adjust the derailleur.

### BRIEF DESCRIPTION OF THE DRAWINGS

FIGS. 1-A, 1-B, 1-C, and 1-D depict an example of a rear derailleur tuning process, in accordance with various embodiments.

FIGS. 1-E, 1-F, 1-G, and 1-H depict an alternative example of a rear derailleur tuning process, in accordance with various embodiments.

FIG. 2 depicts an example of a bicycle with a plurality of targets coupled thereto, in accordance with various embodiments.

FIG. 3 depicts an example of a frame target, in accordance with various embodiments.

FIG. 4 depicts an example of a frame target mount, in accordance with various embodiments.

FIG. 5 depicts an example of a cassette target, in accordance with various embodiments.

FIG. 6 depicts an alternative view of the example of the cassette target, in accordance with various embodiments.

FIG. 7 depicts a view of a derailleur target, in accordance with various embodiments.

FIG. 8 depicts a view of a derailleur target mount, in accordance with various embodiments.

FIG. 9 depicts a view of a jockey target, in accordance with various embodiments.

FIG. 10 depicts an alternative view of a jockey target, in accordance with various embodiments.

FIG. 11 depicts an example of a pose determination algorithm, in accordance with various embodiments.

FIG. 12 depicts an example computing system, in accordance with various embodiments.

FIG. 13 depicts an example close-up view of a target coupled with a mount, in accordance with various embodiments.

FIG. 14 depicts a view of an alternative example mounting system for a derailleur target, in accordance with various embodiments.

FIG. 15 depicts an alternative view of the mounting system of FIG. 14, in accordance with various embodiments.

FIG. 16 depicts an alternative view of the mounting system of FIG. 15, in accordance with various embodiments.

### DETAILED DESCRIPTION OF EMBODIMENTS OF THE INVENTION

In the following detailed description, reference is made to the accompanying drawings that form a part hereof, and in which are shown by way of illustration embodiments that may be practiced. It is to be understood that other embodiments may be utilized and structural or logical changes may be made without departing from the spirit or scope of the present disclosure. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

In embodiments, one or more targets may be coupled with a mechanical system such as bicycle. In some embodiments, the targets may include one or more of a derailleur target, a frame target, a jockey target, and/or a cassette target. A user may use a computing device, for example a smart phone, a tablet, a personal digital assistant (PDA), a laptop, or some other computing device to capture an image of the targets. Specifically, the user may direct a digital camera coupled with, or integrated into, the computing device to capture the image. Each of the targets may have one or more sub-targets (hereafter called “dots” for ease of distinguishing from the “targets”). After image acquisition, the computing device may execute an application which guides the user through adjusting different settings on a component of the bicycle such as the rear derailleur to precisely calibrate and adjust the derailleur with minimal cost or effort to the user. Specifically, the application may be an application which may run on a smart phone in conjunction with a set of targets temporarily or permanently affixed to the rear shifting assembly of a bicycle that guides a cyclist or user through the derailleur adjustment process by using machine vision technology to provide exact adjustment values and diagnostics. In embodiments, the targets may be three-dimensional (3D) which may allow the computing device or the digital camera to readily solve the pose of each target in 3D space with a single image. This allows the possibility that the device can be hand-held. The 3D poses may assist in solving for complex geometry such as the bicycle frame and/or derailleur swing. The application may also show computer generated augmentation on top of the captured photo to enhance the user experience and usability of the application.

A brief discussion of a bicycle derailleur and its related adjustment mechanisms may be useful. Specifically, a derailleur may include a high screw, a low screw, a barrel nut, and a B-screw. In embodiments, the high screw may adjust the positioning of the derailleur with respect to the cassette when the bicycle is in a high gear (e.g. the chain is coupled with the smallest gear or sprocket of the bicycle cassette, which may be typically the gear that is farthest from the bicycle wheel), and the low screw may adjust the positioning of the derailleur with respect to the cassette when the bicycle is in a low gear (e.g. the chain is coupled with the largest gear or sprocket of the cassette, which may be the gear that is closest to the bicycle wheel). The B-screw may adjust the angle or positioning of the derailleur in order to affect the body clearance (i.e. the distance between the jockey pulley and the cassette sprocket). The derailleur may further be coupled with a barrel nut which may tension the cables attaching the derailleur to a shifter. In common operation one or more of the high screw, low screw, b screw and/or barrel nut may be rotated to adjust the derailleur. In some embodiments the amount of rotation may be a quarter of a turn or an eighth of a turn at a time. In other embodiments, the screws and/or nut may be rotated a greater or lesser amount.

As used herein to refer to sub-targets of a target such as a jockey target, frame target, derailleur target, or cassette target, the term “dot” is not intended to be limiting in any way, and instead is merely used to distinguish the individual markings on a “target.” In embodiments, the targets may include one or more dots. The dots may be permanently or removably coupled with the targets, and may each include one or more lines, shapes, and/or geometric patterns. In some embodiments, the “dots” may have non-uniform shapes, sizes, and/or geometric patterns which may be used in identifying the location and/or orientation of one or more targets.

As an overview of a tuning process, in some embodiments an application may be started on a user device such as a smartphone, a camera, a tablet, a laptop, or some other camera-equipped user device. When the application is started, the user may select a history file from a list of saved user bicycles. The user device may then be pointed at the bicycle such that one or more targets coupled with the bicycle are in the field of view of the camera. In some embodiments, the application may provide feedback to the user which the user may use to adjust the camera view of the targets and bicycle. When the application determines that the camera is able to capture a sufficient image, or upon manual activation by the user, an image such as a high resolution image may be taken of the bicycle and the targets. The image may be used to calculate the position of the derailleur, cassette, and/or frame of the bicycle in 3D space based on the position of the targets. The application may determine a component (e.g. derailleur) adjustment/correction, which may involve adjustment of one or more of the high screw, the low screw, the b screw, and/or the barrel nut, and instruct the user how to perform such adjustments. For example, the application may direct the user to turn the high screw a quarter turn. In embodiments, the application may also provide feedback regarding which direction (e.g. clockwise or counter-clockwise) to turn the high screw.

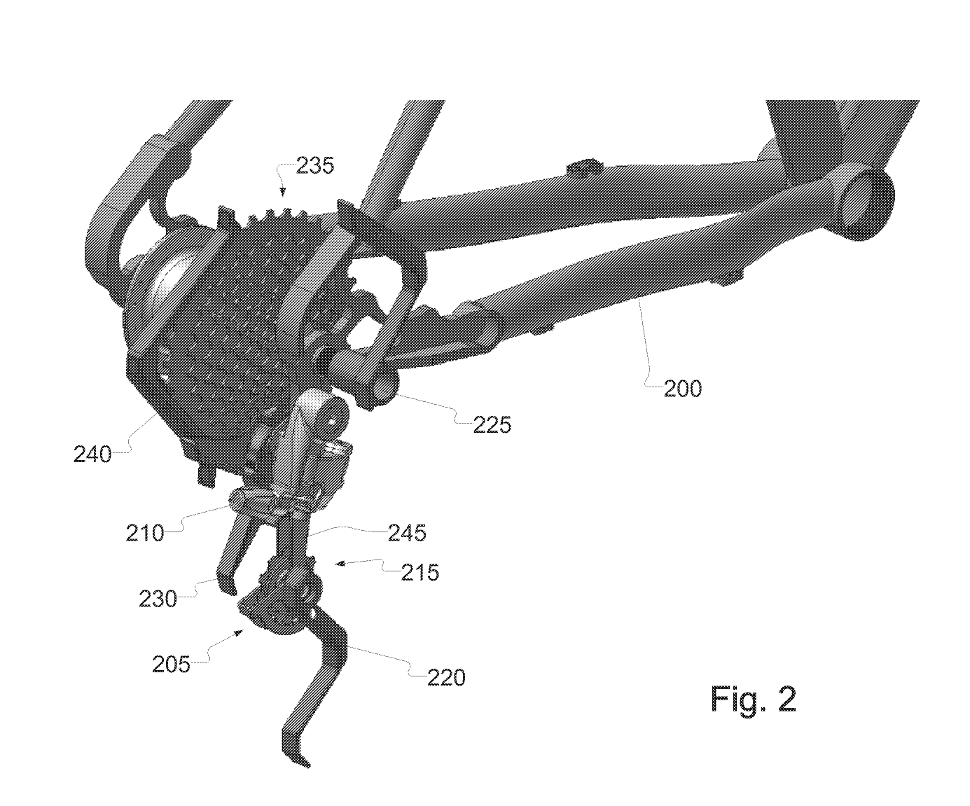

FIG. 2 depicts an example image of a bicycle with a plurality of targets attached to it. Specifically, the bicycle may include a frame 200. The frame may be coupled with a rear derailleur 205 that is configured to tension a chain (not shown herein for clarity). The rear derailleur 205 may be adjusted by actuation of a hand lever or shifter, as described above. The hand lever may adjust the tension on a rear derailleur cable (not shown herein for clarity) that may pass through an adjustable barrel nut 210, as described above. In some embodiments the rear derailleur 205 may include an idler pulley 215 configured to tension the chain. In some embodiments the rear derailleur 205 may include a derailleur cage 245. The idler pulley 215 or derailleur cage 245 may be coupled with a derailleur target 220, as will be described in greater detail below. In the following discussion, the derailleur target 220 may only be described as coupled to the idler pulley 215 for ease of explanation, however it will be understood that in other embodiments the derailleur target 220 may be coupled with the derailleur cage 245. The frame 200 may be coupled with a frame target 225, as will be described in greater detail below. In some embodiments the rear derailleur 205 may further be coupled with a jockey target 230, as will be described in greater detail below. The cassette 235 may be coupled with a cassette target 240, as well be described in greater detail below.

In some embodiments, the bicycle may further include a cassette 235 comprising a plurality of sprockets of different sizes. In some embodiments a cassette 235 may have 9 or 10 sprockets, though in other embodiments the cassette 235 may have more or less sprockets. Typically, the sprocket with the largest diameter in the cassette 235 may be located closest to a center line of the frame, and be considered the “low” gear or “first” gear, while the sprocket with the smallest diameter may be located further from the center line of the frame and be considered the “highest” gear. In some embodiments the cassette 235 may be coupled with a cassette target 240, as described in further detail below.

### Quick Tune

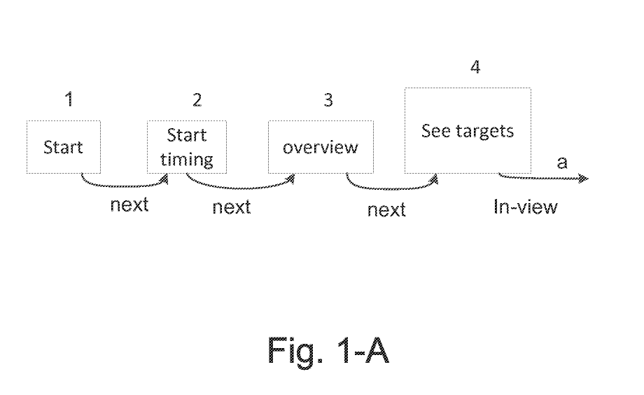

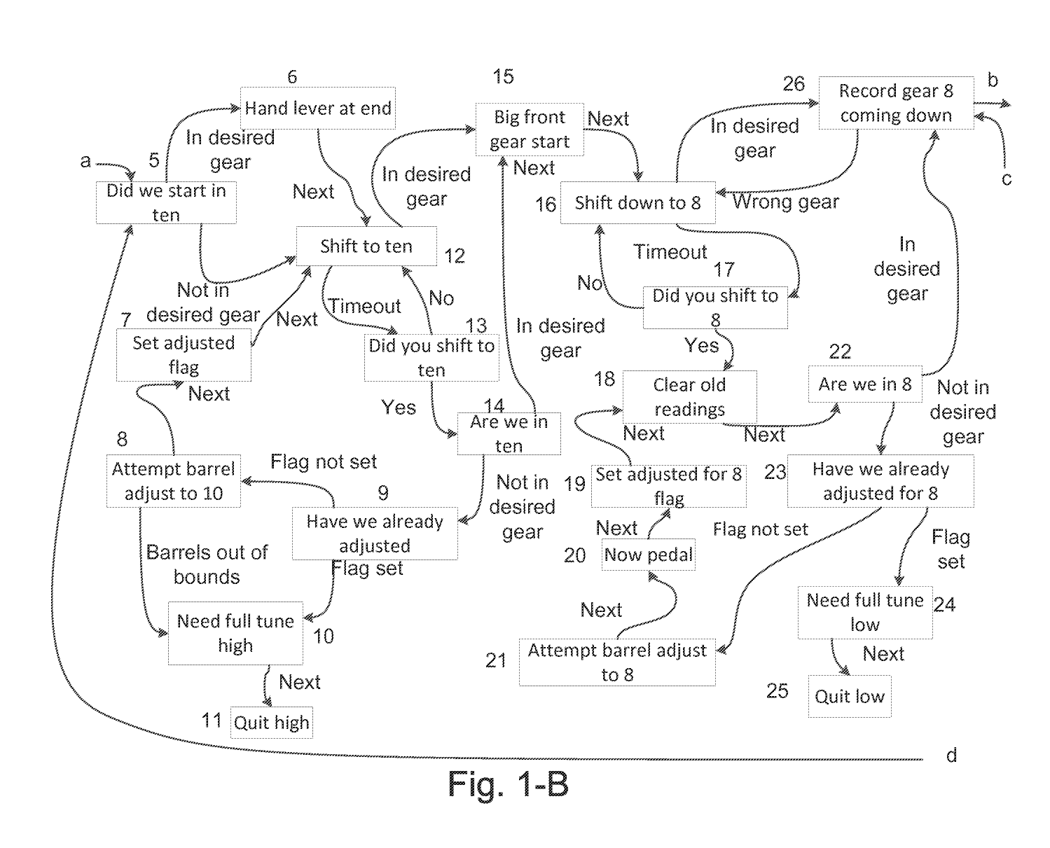

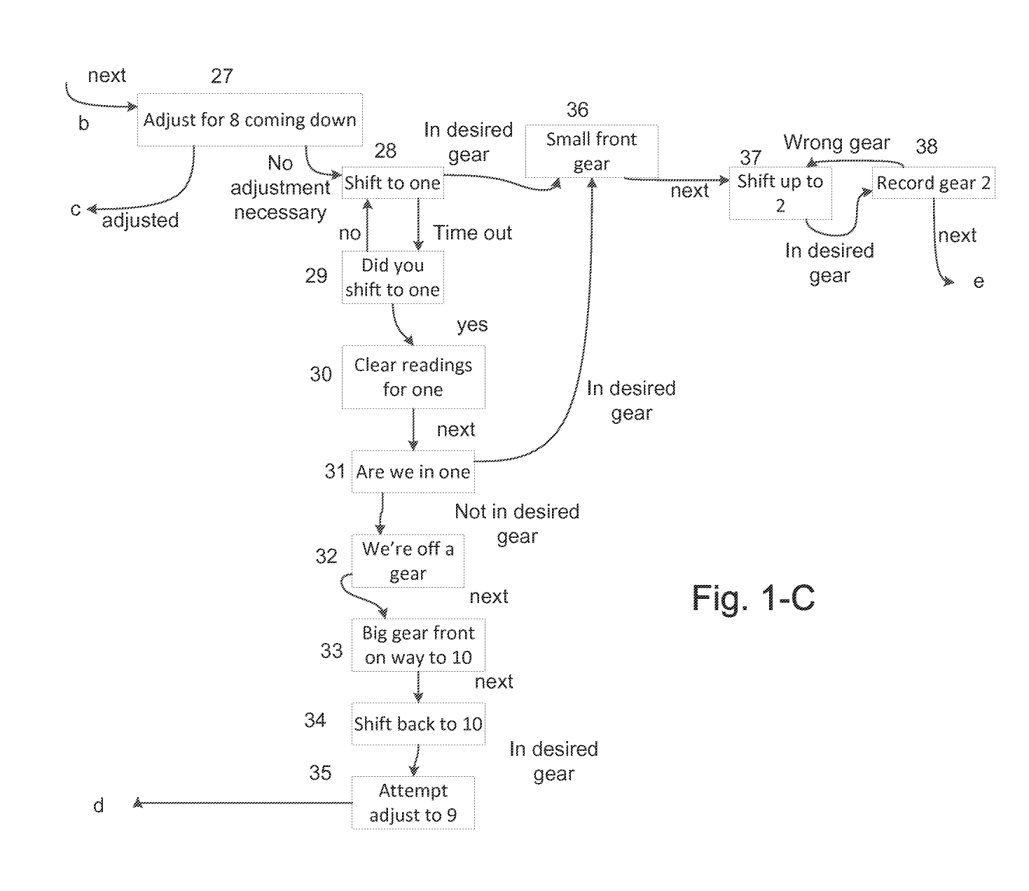

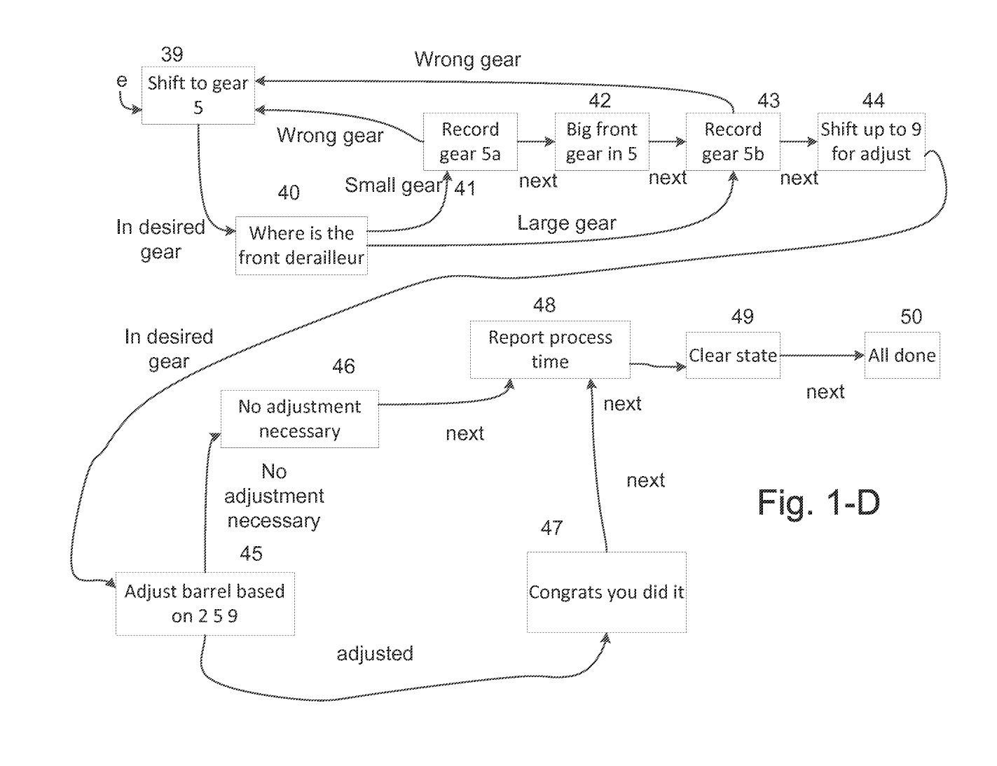

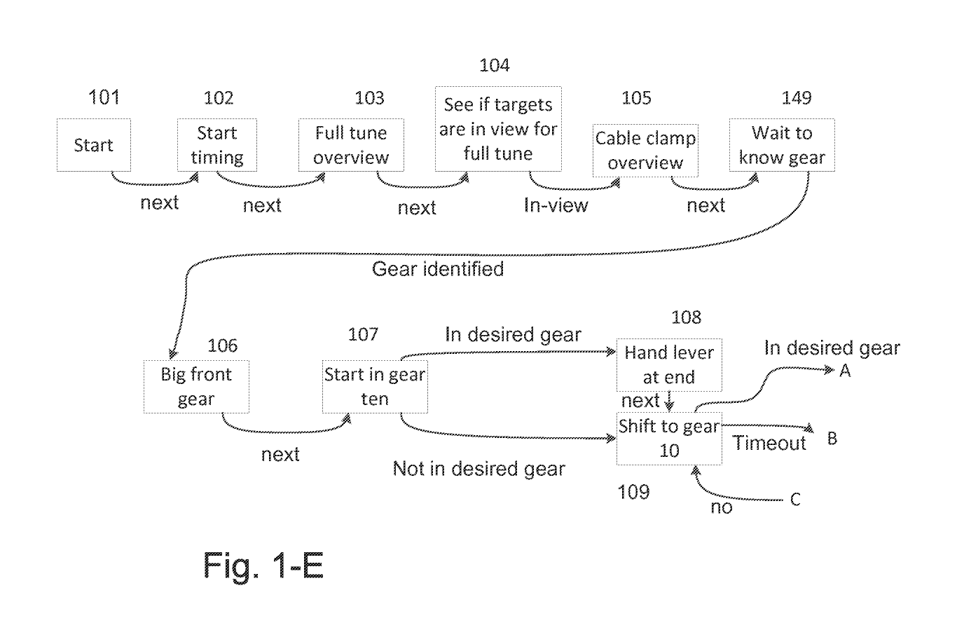

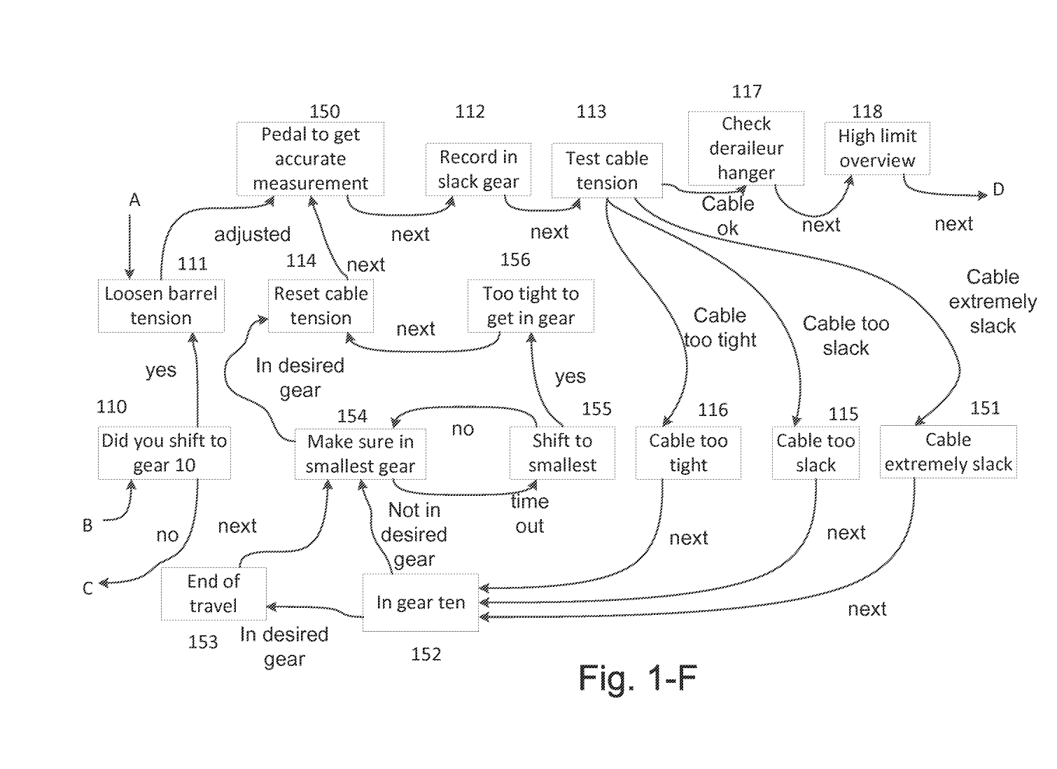

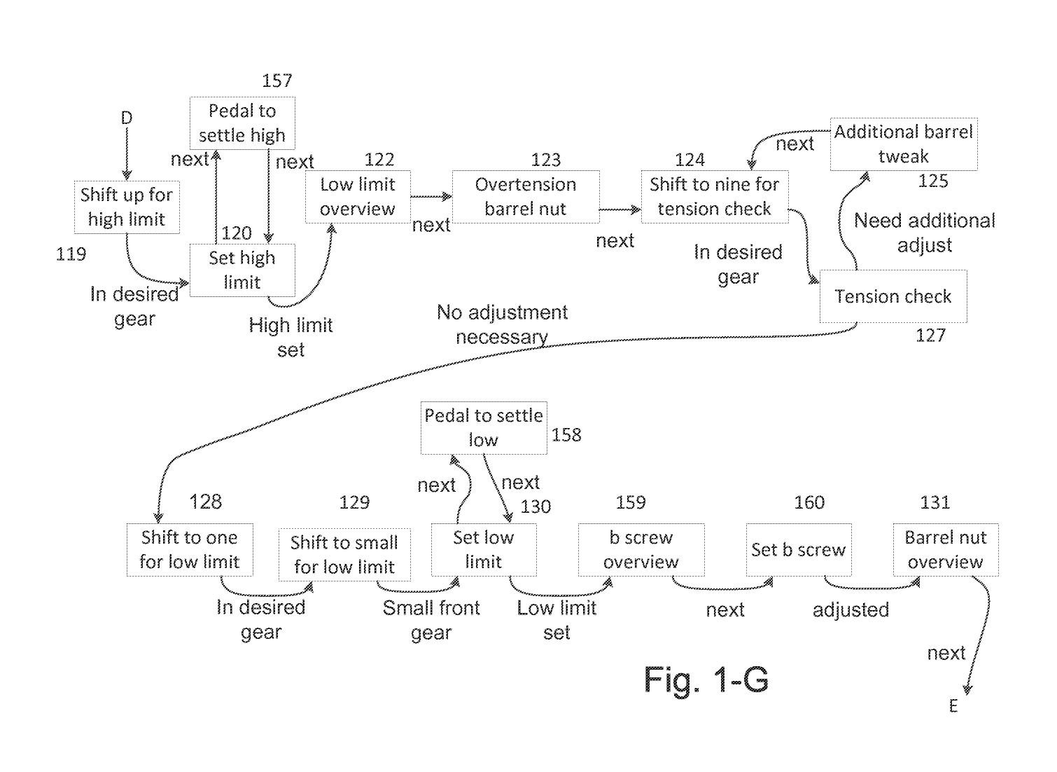

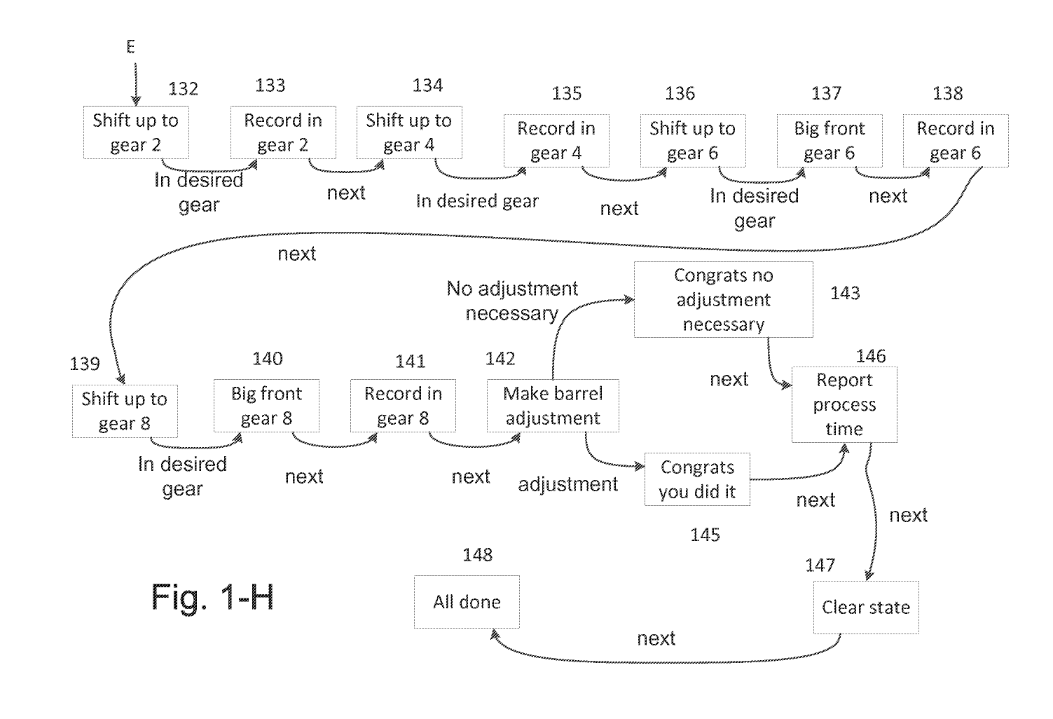

FIGS. 1-A, 1-B, 1-C, and 1-D may describe the performance of a Quick tune process by a computing device or system such as a smart phone, a tablet, a computer, or some other type of computing device. As described herein, the Quick tune process is described with respect to a bicycle, though in other embodiments the Quick tune process may be performed with respect to a different type of mechanical device or system. It will be understood that the process described below is merely one example of a process, and in other embodiments one or more of the elements of the Quick tune process may be added, removed, or otherwise altered.

To the extent that the system may be described as communicating information to or asking a question of a user, the system may communicate using one or more of a visual cue, haptic feedback, an audio cue, or some other means of communicating information from a computing device. Additionally, to the extent that the user is described as responding to a question or prompt, the user may use one or more of a keyboard, a mouse, a touch screen, a spoken response, or some other form of information communicating device. Additionally, to the extent that a specific wording of a question or response such as “yes” or “no,” may be described, it will be understood that this specific wording is an example only and other words may be used to indicate similar responses or affirmations.

Additionally, the different elements of the Quick tune process may be referred to with respect to FIG. 2 as described above. For example, when “targets” are described in the Quick tune process, the “targets” may refer to one or more of the cassette target 240, the derailleur target 220, the jockey target 230, and/or the frame target 225. The “rear derailleur” described with respect to the Quick tune process may refer to rear derailleur 205, and the cassette may refer to cassette 235. The “barrel nut” may refer to barrel nut 210.

The Quick tune process may begin in state 1, passing to state 2. In state 2 a timer may begin to increment. The timer may be used to track the time it took the user to complete the Quick tune process. At state 3, an overview may describe the Quick tune process to the user. The process may then move into state 4 where the system may ask the user to place a digital camera such as a smartphone camera, a tablet camera, a digital camera, a web camera, or some other type of digital camera in view of the targets. In general, the targets may be required to be in view, and the pose must be found for all targets as described in greater detail below before passing from State 4.

At state 5, the process may analyze the targets and calculate the gear the derailleur is currently in. If the derailleur is already in the highest rear gear, then the process may pass to state 6. If the derailleur is not in the highest rear gear, then the process may pass to state 12. At state 6, the system may ask the user to make sure the hand lever (i.e. the bicycle shifter) is shifted all the way towards its highest position, even though the chain may already be in its highest rear position, and then passes to state 12. At state 12 the system may ask the user to shift the hand lever to its highest position allowing the chain to move to the highest rear gear. Specifically, in state 12, the system may take one or more images of the targets, solve for the pose of the targets as described in greater detail below, and calculate derailleur gear position based on the calculated poses.

If a timeout expires before the requested gear position is achieved, the process may pass to state 13. If the desired gear position is “viewed,” in other words detected based on one or more images and the calculated poses of the targets in the images, and the gear is found to be in tenth gear, the flow may pass to state 15. At state 13, the system may ask the user the question “did you shift to ten?” If the user answers “no,” the process may pass back to state 12. If the user answers “yes,” the process may pass to state 14.

At state 14, the process may recheck whether the derailleur is now in the highest rear gear. If the derailleur is in the highest gear, the process may pass to state 15. If the rear derailleur is not in the highest gear, then the flow may pass to state 9. At state 9, the process may check a software flag to determine if an adjustment was already made. If it is determined that an adjustment was already made, the process may pass to state 10. At state 10, the system may notify the user that the rear derailleur needs a more in-depth adjustment and to use the Full tune workflow described in greater detail below. The process may then pass to state 11, quitting the Quick tune workflow. In state 9, if an adjustment was not already made, the process may pass to state 8. At state 8, the system may calculate the number of turns of the barrel nut required to adjust the rear derailleur. If the calculated adjustment is within the range of a typical barrel nut, then instructions may be given to the user to make the adjustment, and the process may then proceed to state 7. If the calculated adjustment is larger than the typical range of a barrel nut, then the process may pass to state 10 without the system instructing the user to make any adjustments. At state 7, the system may set the adjustment flag indicating a base adjustment has been attempted, and then the process may pass to state 12. At state 15, the system may check the angle of the rear derailleur cage about the cassette axis in relation to the gear train to determine what front gear the chain is on. If the bicycle is in the low front gear, the user may be asked to shift to the front high gear.

The system may then continuously monitor the derailleur angle and calculate the front gear position. Once the front gear has been determined to be in the high position, the process may pass to state 16. If the front gear is determined to be already in the high position, then the process may pass to state 16 without generating and/or displaying any user instructions. At state 16, the system may instruct the user to shift the rear derailleur two positions lower. The system may continuously monitor the rear gear position while the user shifts. If the requested gear position is “viewed”, i.e. a camera coupled with the system identifies that the rear derailleur is in the requested gear position, the process may then pass to state 26. If the requested gear is not “viewed” and a timeout expires, then the process may pass to state 17. At state 17, the system may ask the user the question: “did you shift to 8?” If the user answers “no,” for example by providing an input to an input device coupled with the system such as a touchscreen, a mouse, a keyboard, a microphone, or some other input device, the process may pass back to state 16. If the user answers “yes,” the process may pass to state 18.

At state 18, the process may clear any outdated state information and pass to state 22. At state 22 the system may identify whether the rear derailleur is in gear 8. If the rear derailleur is in gear 8, then the process may pass to state 26. If the rear derailleur is not in gear 8, then the process may pass to state 23. At state 23 the system may check a software flag to identify or determine if an adjustment was already made by a user.

If an adjustment was already made by the user, the process may pass to state 24. At state 24 the system may instruct the user that the rear derailleur needs a more in-depth adjustment, and to use the Full Tune workflow, as further detailed below. The process may then pass to state 25, quitting the Quick Tune workflow.

In state 23, if an adjustment was not already made, the process may pass to state 21. At state 21 the system may calculate the number of turns of the barrel nut required to adjust the rear derailleur. Instructions may be given to the user to make the adjustment, and the process may pass to state 20. At state 20 the system may remind the user to pedal, i.e. rotate the pedals of the bicycle thereby rotating the chain and allowing the rear derailleur to shift gears. The process may then pass to state 19. At state 19, the system may set the adjustment flag indicating a base adjustment has been attempted. The process may then pass to state 18.

At state 26, the system may check the position of the rear derailleur. If the rear derailleur is in the requested position, then the position of the rear derailleur may be recorded under the condition of the chain is positioned on the eighth gear and the shifter cable is in a tensioned state. The process may then pass to state 27. If the rear derailleur is not in the requested gear, then the process may return to state 16. At state 27, the system may calculate the number of turns of the barrel nut required to adjust the rear derailleur. The user may be instructed to make the “rough” adjustment. Afterwards, if an adjustment was required, then the process may return to state 26. If no adjustment is required in state 27, the process may proceed to state 28.

At state 28 the system may instruct the user to shift the rear derailleur to the lowest gear (i.e. first gear or “gear one”). The system may monitor the derailleur position and calculate the current gear. If the timeout expires, the process may pass to state 29. If the system “sees” or otherwise identifies that the rear derailleur has been shifted to the lowest rear gear, then the process may pass to state 36.

At state 29, the system may ask the user the question: “Did you shift to first gear?” If the user answers “no,” the process may pass back to state 28. If the user answers “yes”, the process may pass to state 30. At state 30 the system may clear all recorded positions of the derailleur from the memory, and then the process may then pass to state 31. At state 31 the system may monitor the derailleur position and calculate the current gear. If the calculated gear is that of the requested gear, i.e. first gear, then the process may pass to state 36. If the calculated gear is not the desired gear, then the process may pass to state 32. At state 32 the system may inform the user that the rear derailleur is misadjusted by one full gear and pass to state 33. At state 33 the system may check the position of the front gear, i.e. the front derailleur. If the front derailleur is in the low position, the system may ask the user to shift the front gear set to the highest position. The process may then pass to state 34. At state 34 the system may instructs the user to shift the rear derailleur to the highest position, then pass to state 35. At state 35 the system may measure the rear derailleur position, calculate the required barrel adjustment to move the rear derailleur one full gear lower, and instruct the user to make the adjustment. The system may monitor the adjustment and provide feedback, and the process may pass to state 5.

At state 36, the system may check the angle of the rear derailleur cage about the cassette axis in relation to the gear train to determine what front gear the chain is on. If the bicycle is in the high front gear, the system may ask the user to shift to the front low gear. The system may continuously monitor the derailleur angle and calculate the front gear position. Once the front gear has been determined to be in the low position, the process may pass to state 37. If the front gear is determined to be already in the low position, then the process may pass directly to state 37 without generating or communicating any user instructions. At state 37, the system may instruct the user to shift the rear derailleur to the second gear position. The system may monitor the position of the derailleur, calculating the current gear position of the rear derailleur. The user may be continuously updated regarding the number of gear positions to move as the user is shifting. Once the rear derailleur is identified as being in second gear the process may proceed to state 38. At state 38 the system may recheck the position of the rear derailleur before recording the position of the rear derailleur. If the position of the rear derailleur is no longer in second gear at the time of recording, the process may to state 37.

After recording that the rear derailleur is in second gear at state 38, the process may pass to state 39. At state 39, the system may instruct the user to shift the rear derailleur to the fifth gear. The system may monitor the position of the rear derailleur, calculating the current gear position of the rear derailleur. The user may be continuously updated regarding the number of gear positions to move in real time. Once the rear derailleur is found to be in fifth gear, the process may pass to state 40. At state 40, the system may check the angle of the rear derailleur cage about the cassette axis in relation to the gear train to determine what front gear the chain is on. If the front gear has been determined to be in the low position (i.e. the small gear), the process may pass to state 41. If the front gear is determined to be in the high position (i.e. the larger gear), then the process may pass to state 43. At state 41, the system may check the position of the rear derailleur. If the rear derailleur is in the requested position, then the position of the rear derailleur is recorded under the condition of the chain being positioned on the fifth gear, the shifter cable being in a slackened state, and the front derailleur being in the low position. This position may be known as gear “5a.” The system may then pass from state 41 to state 42 if the rear derailleur remains in fifth gear. If the position of the rear derailleur is other than fifth gear, then the process may return to state 39. At state 42, the system may instruct the user to shift the front derailleur to the large gear. Additionally, at state 42, the system may check the angle of the rear derailleur cage about the cassette axis in relation to the gear train to determine what front gear the chain is on. Once the front gear has been determined to be in the high position (i.e. the large gear), the process may pass to state 43. At state 43, the system may check the position of the rear derailleur. If the rear derailleur is in the requested position, then the position of the rear derailleur may be recorded under the condition of the chain is positioned on the fifth gear, the shifter cable is in a slackened state, and the front derailleur is in the high position. This gear may be known as gear “5b.” The process may then pass to state 44 if the rear derailleur is still in fifth gear. If the position of the rear derailleur is other than fifth gear, then the process may return to state 39. At state 44 the system may instruct the user to shift the rear derailleur to the ninth gear. The system may monitor the position of the rear derailleur, calculating the current gear position of the rear derailleur. The user may be continuously updated to the number of gear positions to move in real time. Once the rear derailleur is found to be in ninth gear the process may pass to state 45.

At state 45, the system may check the position of the rear derailleur. If the rear derailleur is in the requested position, then the position of the rear derailleur may be recorded under the condition of the chain being positioned on the ninth gear. The recorded derailleur positions in gears 2, 5a, 5b, and 9 may be used to identify a barrel nut position that corresponds to a reduced or least amount of offset for all recorded shift positions. The calculation process may average the number of ⅛ turns, or some other increment of turns, of the barrel nut required to align one or more of the derailleur positions. In some embodiments, the calculation process may be based on a least-square sum of a plurality of different adjustment options. If the barrel adjustment is greater than some minimal value, for example a single turn, two turns, etc., then the user may be instructed to make the adjustment to the barrel nut and the process may pass to state 47. If the calculated barrel adjustment is less than the minimal value, then the process may pass to state 46. At state 46 the system may inform the user that no adjustment is needed and pass to state 48. At state 47, the system may inform the user they are done with the Quick tune process and pass to state 48. At state 48 the system may stop the timer that was begun at state 2. The elapsed time may be reported to the user, and then the process may pass to state 49. At state 49, the system may clear all states, then proceed to state 50 which may conclude the Quick Tune Process.

### Full Tune

FIGS. 1-E, 1-F, 1-G, and 1-H may describe the Full tune process from the point of view of a computing device such as a smart phone, a tablet, a computer, or some other type of computing device. The Full tune process may be performed on a mechanical device or system such as a bicycle. It will be understood that the process described below is merely one example of a process, and in other embodiments one or more of the elements of the Full tune process may be added, removed, or otherwise altered.

To the extent that the system may be described as communicating information to or asking a question of a user, the system may communicate using one or more of a visual cue, haptic feedback, an audio cue, or some other means of communicating information from a computing device. Additionally, to the extent that the user is described as responding to a question or prompt, the user may use one or more of a keyboard, a mouse, a touch screen, a spoken response, or some other form of information communicating device. Additionally, to the extent that a specific wording of a question or response such as “yes” or “no,” may be described, it will be understood that this specific wording is an example only and other words may be used to indicate similar responses or affirmations. Finally, to the extent that the Full tune process describes the user pressing “continue,” in other embodiments a different action may be performed by the user such as a spoken command, or a different prompt may be displayed to the user.

Additionally, the different elements of the Full tune process may be referred to with respect to FIG. 2 as described above. For example, when “targets” are described in the Full tune process, the “targets” may refer to one or more of the cassette target 240, the jockey target 230, the derailleur target 220, and/or the frame target 225. The “rear derailleur” described with respect to the Full tune process may refer to rear derailleur 205, and the cassette may refer to cassette 235. The “barrel nut” may refer to barrel nut 210.

The Full tune process begins in state 101, passing to state 102. In state 102, a timer may begin to increment. The timer may be used to tell the user the time it took to complete the Full tune process, then the process may pass to state 103. In state 103, the system may describe the Full tune process to the user, for example via an audio prompt, a visual display, or some other method of communicating with a user, then the process may pass to state 104. At state 104, the system may ask the user to place a camera such as a digital camera, a smartphone camera, a web camera, or some other type of camera in view of targets coupled with the mechanical device or system. In embodiments, one or more, and in some cases all, of the targets must be in view and the pose must be found for all targets before passing to state 105. At state 105 the system may describe a cable clamp overview to the user before passing to state 149. At state 149 the system may pause the process and identify the angle of the rear derailleur until the system is able to identify what gear position the user is in, that is the physical position of the bicycle chain and/or rear derailleur with respect to the bicycle cassette. When this position this information is found the process may pass to state 106.

At state 106 the system may check the angle of the derailleur arm to determine the chain position at the crank that is at the front gears of the bicycle. If the chain is found to be in the small front sprocket, then the user may be instructed to shift the front derailleur to the largest gear. If the chain is already in the front largest sprocket, then the process may pass to state 107. At state 107 the system may check the location of the rear derailleur and determines which rear gear the chain is in. If the chain is found to be in the smallest rear gear, then the process may pass to state 108. If the chain is found to not be in the smallest rear gear, then the process may pass to state 109. At state 108 the system may remind the user to shift the rear derailleur hand lever to its most slack position despite the position of the chain, then the process may pass to state 109.

At state 109 the process may instruct the user to shift to the smallest rear gear, start a timeout timer, and subsequently monitor the position of the rear derailleur. If the derailleur moves to the requested gear position, then the process may pass to state 111. If the timeout timer elapses, then the process may pass to state 110. At state 110 the system may ask the user if the hand lever that controls the rear derailleur was shifted. If the user responds “no,” then the process may pass to state 109. If the user responds with “yes,” then the process may proceed to state 111, but in some embodiments the system may set a Flag indicating that the mechanical system is not able to get into the smallest gear. If the rear derailleur is not in the smallest rear gear, then the process may pass to state 111.

At state 111 the system may instruct the user to fully loosen the barrel nut (which may slacken the derailleur cable) before continuing. After the user has indicated compliance with the instructions, the process may pass to state 150 at which the system may instruct the user to pedal the crank. Once a timer elapses the process may pass to state 112. At state 112 the system may record the position of the rear derailleur before passing to state 113. At state 113 the system may instruct the user to shift the rear derailleur two gear positions larger. The position of the rear derailleur may then be evaluated compared to the ideal position for the requested gear. If the position of the rear derailleur is found to be too far towards the next largest gear, then the process may pass to state 116. If the position of the rear derailleur is found to be too far towards the next smaller gear, then the process may pass to state 115. If the position of the rear derailleur is found to be within an acceptable range for the requested gear, then the process may pass to state 117. If the position is found to not have moved then the system may ask the user if the hand lever was indexed. If the user answers “no,” then the process may continue to loop within state 113. If the user answers “yes,” then the process may pass to state 151.

At state 115 the system may inform the user that the cable is too slack. The system may then record the offset of the rear derailleur as compared to an ideal or desired position for the rear derailleur, and then pass to state 152. At state 116 the system may inform the user that the rear derailleur cable is too tight. The system may then record the offset of the rear derailleur as compared to an ideal or desired position for the rear derailleur, and then pass to state 152. At state 151 the system may inform the user that the rear derailleur cable is too loose, and the system may set a flag configured to indicate that the rear derailleur cable is more than one index position out of adjustment, then the system may proceed to state 152.

At state 152 the system may check to identify if the rear derailleur is in the position of the smallest diameter rear gear. If the rear derailleur is in the position of the smallest rear gear, then the process may pass to state 153. If the rear derailleur is not in the position of the smallest rear gear, then the process may pass to state 154. At state 153 the system may instruct the user to shift the rear derailleur hand lever to the highest gear (i.e. the smallest sprocket in the rear cassette) position, then indicate that they have done so, for example by pressing or saying “continue” on an input of the computing device. The process may then pass to state 154.

At state 154 the system may check to determine whether the rear derailleur is in the position of the smallest rear gear. If the rear derailleur is in the position of the smallest rear gear, then the process may pass to state 114. If the rear derailleur is not in the position of the smallest rear gear, the user may be instructed to shift to the smallest rear gear, for example using the hand lever or rear shifter. A timeout timer may be started, and the rear derailleur position may be monitored. If the rear derailleur is found to move to the desired gear, the process may pass to state 114. If the timeout timer elapses, the process may pass to state 155. At state 155 the system may ask the user if the rear derailleur hand lever was indexed to the highest gear (i.e. the smallest sprocket) position. If the user answer “no,” then the process may pass to state 154. If the user answers “yes,” then the process may pass to state 156. At state 156 the system may inform the user that the cable is too tight to get into gear, and the cable clamp adjustment will be performed in the correct gear position. A flag may be set by the system, which may signify the cable clamp adjustment will be performed in this gear. The process may then pass to state 114. At state 114 the system may direct the user to adjust the cable clamp setting. If state 115 or 116 were passed, state 114 may instruct the user to loosen the cable clamp, slide the cable a specified direction and/or amount, then retighten the cable clamp. If state 151 was passed, state 114 may direct the user to loosen the cable clamp, pull slack out of the shifter cable, then retighten the cable clamp. Regardless of passing state 115, 116, or 151, state 114 may pass to state 150 after the user indicates that they have performed the suggested adjustment, for example by pressing “continue.”

At state 117 the system may inspect the angle between the plane of the jockey pulley and the plane of the cassette gear. If the inspected angles are not within an acceptable range, then the user may be informed by the system that the derailleur hanger is bent and should be corrected or fixed, and then the process may pass to state 118. If the inspected angles are found to be within an acceptable range, then the user may be informed that the derailleur hanger is straight and the process may pass to state 118. At state 118 the system may provide the user with an overview of the high limit setting process, then proceed to state 119. At state 119 the system may instruct the user to shift to the smallest rear gear, for example by indexing the shifter or hand lever. The system may then monitor the derailleur position. The user may be periodically directed by the system with indications or directions related to the direction and number of shifts required, e.g. “up two gears,” “down one gear,” or some other indication. When the rear derailleur is found to be stationary in the required gear, the process may pass to state 120.

At state 157 the system may instruct the user to peddle the crank and start a timer. Once the timer elapses the process may pass to state 120. At state 120 the system may calculate the offset of the rear derailleur's current position to a preferred or desirable position for the requested gear, then pause and pass to state 157. On return to state 120 the calculated offset may be used to identify the direction and amount the high limit screw may need to be adjusted or rotated to reduce or cancel the calculated. The user may be instructed to adjust the high limit screw the specified direction and amount, then indicate that they have done so for example by pressing or otherwise entering “continue” into an input of the computing device, which point the process pass to state 157. On return to state 120 the process may repeat until the calculated offset is reduced below an acceptable limit, then the process may pass to state 122.

At state 122 the system may provide an overview of the Low Limit screw adjustment to the user, and then pass to state 123. At state 123 the system may identify the position of the chain in the front sprocket by measuring the angle of the derailleur arm. If the chain is not in the largest front gear, then the user may be instructed to shift to the largest front sprocket. If the chain is in the largest front gear, then the instruction to shift the front derailleur may be skipped. The position of the chain in the rear sprocket may then likewise be determined. If the chain is not in the smallest rear gear, then the user may be instructed to shift to the smallest diameter rear gear. If the chain is in the smallest rear gear, then the instruction to shift the rear derailleur may be skipped. The direction and amount of a barrel nut adjustment may then be calculated to bias the rear derailleur's position towards the next larger rear sprocket. The user may be instructed to make the specified adjustment to the barrel nut. Once the user indicates that they have made the barrel nut adjustment, the process may pass to state 124. At state 124 the system may instruct the user to shift the rear derailleur to the next larger rear gear. The rear derailleur position may be monitored and, once the rear derailleur is in a desired position, the process may pass to state 127. At state 127 the system may then check the rear derailleur's position. If the rear derailleur's position is within an acceptable range of the bias calculated in state 123, then the process may pass to state 128. If the derailleur position is not within an acceptable range of the bias calculated in state 123, then the process may pass to state 125. At state 125 the system may inform the user that an additional adjustment is needed, and then pass to state 124. At state 128 the system may instruct the user to shift the rear derailleur to the largest gear. The rear derailleur position may then be monitored. Once the rear derailleur is in the required position, the process may pass to state 129. At state 129 the system may instruct the user to shift the front derailleur to the smallest diameter gear and the rear derailleur angle (which may, through length of the chain, indicate the position of the front derailleur) may be monitored. Once the front derailleur is in the required position, the process may pass to state 130.

At state 130 the system may calculate the offset of the rear derailleur's current position to a desired or preferred position for the requested gear then, pause and pass to state 158. At state 158 the system may instruct the user to pedal the crank, and the system may start a timer. Once the timer elapses the process may pass to state 130. On return to state 130 the calculated offset may be used to identify the direction and amount of adjustment needed of the low limit screw to reduce, minimize, or cancel the calculated offset. The user may be instructed to adjust the low limit screw a specified direction and amount, then press, say, or otherwise input “continue” to the computing device. Once “continue” is input, the process may pass to state 158. On return to state 130 the process may repeat until the offset is reduced below an acceptable limit, then the process may pass to state 159.

At state 159 the system may provide an overview of the B-Screw adjustment to the user, and then pass to state 160. At state 160 the system may determine the position of the chain in the front sprocket by measuring the angle of the rear derailleur arm. Next, the gap between the largest gear on the cassette and the top of the jockey pulley may be determined. If the gap is within an acceptable range, then the user may be told that the B-screw adjustment is complete and the process may pass to state 131. If the gap is not with an acceptable range, then the direction and number of turns required of the B-screw to adjust the gap to a preferred or desirable setting may be calculated. The user may be instructed to adjust the B-screw a specified direction and amount, then press “continue.” The B-screw adjustment determination may repeat until the gap is within an acceptable range or until a set number of iterations has lapsed, then the process may pass to state 131.

At state 131 the system may provide an overview of the barrel nut adjustment to the user, and then the process may pass to state 132. At state 132 the system may instruct the user to shift the rear derailleur one gear smaller. The rear derailleur position may then be monitored by the system. Once the rear derailleur is in the required position, the process may pass to state 133. At state 133 the system may record the position of the rear derailleur, then the process may pass to state 134. At state 134 the system may instruct the user to shift the rear derailleur two gear positions smaller. The system may then monitor the position of the rear derailleur. Once the rear derailleur is in the required position, the process may pass to state 135. At state 135 the system may record the position of the rear derailleur, then pass to state 136. At state 136 the system may instruct the user to shift the rear derailleur two positions smaller, and the rear derailleur position may be monitored. Once the rear derailleur is in the required position, the rear derailleur position may be recorded and the process may pass to state 137. At state 137 the system may instruct the user to shift the front derailleur to the largest gear, and the rear derailleur angle (which may indicate the position of the front derailleur) may be monitored. Once the front derailleur is in the required position, the process may pass to state 138 where the system may record the position of the rear derailleur, then pass to state 139. At state 139 instructs the user to shift the rear derailleur two positions smaller. The rear derailleur position may then be monitored. Once the derailleur is in the required position, the process may pass to state 140. At state 140 the system may instruct the user to shift to the largest front sprocket, then the system may monitor the angle of the rear derailleur. Once the rear derailleur angle indicates that the chain is in the largest front gear, the process may pass to state 141. At state 141 the system may record the position of the rear derailleur, then pass to state 142. At state 142 the system may calculate the adjustment of the barrel nut required to reduce or minimize the offset of the derailleur from the ideal position at each shift point. For example, the calculation may include a least-mean square type calculation, or some other calculation. The user may then be instructed to adjust the barrel nut a specified direction and a specified amount, for example an eighth of a turn clockwise, a quarter of a turn counterclockwise, etc. The user may then press “continue.”

If an adjustment was required, the process may pass to state 145. If no adjustment was needed, the process may pass to state 143. At state 143 the system may inform the user that the barrel nut is already adjusted, and then pass to state 146. At state 145 the system may inform the user the barrel adjustment is complete, and then pass to state 146. At state 146 the system may stop the timer from state 102. The elapsed time that the Full tune process took may be reported to the user along with other metrics. The process may then pass to state 147, at which point the system may clear all states. The process may finally pass to state 148, completing the full tune workflow.

In some embodiments, the computing system may also be configured to determine whether there is a problem with the bicycle or components such as worn cables, a bent derailleur, or some other component error or malfunction. For example, the computing device may be configured to determine whether the plane of the rear derailleur of the bicycle is not parallel with the plane of a cassette, which may indicate that the derailleur hanger of the bicycle frame is bent or the derailleur and/or derailleur linkage of derailleur 205 is damaged as described above with respect to state 117. Additionally, if the computing device determines, using a target such as a derailleur target 220, that the derailleur 205 moves a greater or lesser amount when the shifter is indexed into a higher gear from a lower gear (or vice versa), or the derailleur 205 has a large variation in how far it moves when the shifter is indexed, then the application may determine that a shifter cable or cable sheath is worn and provide such information to the user as described with respect to state 113. Similarly, if the process indicates that the average index spacing, or how far the derailleur 205 moves each time the shifter is indexed, does not match the pitch of the cassette 235, or how far a gear of the cassette 235 is from another gear of the cassette 235, then the application may determine that the derailleur hanger of the rear derailleur 205 is bent, the cable drum is worn, or the derailleur 205 and cassette 235 are mis-matched (e.g. one is a 9-speed component and the other is a 10-speed component, or some other mis-match).

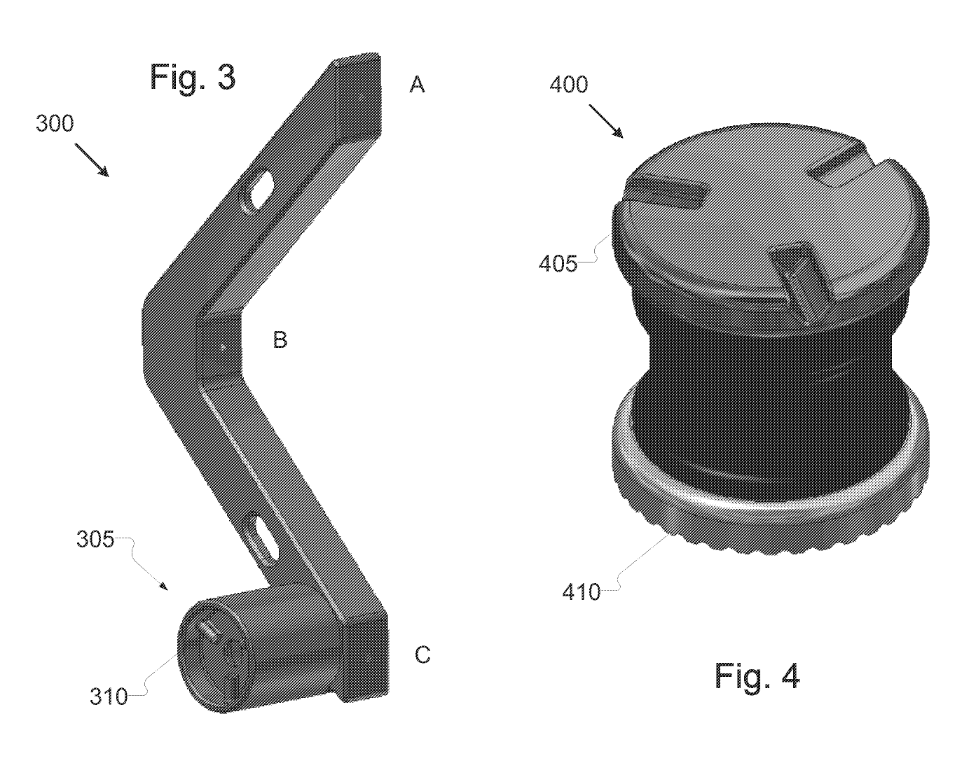

FIG. 3 depicts an example of a frame target 300 which may be used with the application of the present disclosure. The frame target may be similar to frame target 225. The frame target 300 may be coupled with the frame of a bicycle, for example by using a string, strap, band, hook-and-loop (such as Velcro) tie, zip tie, clamp, magnet, wedge, or some other type of fastener. Alternatively, the frame target 300 may be affixed to the bicycle frame such as by taping, gluing, or otherwise adhering the frame target 300 to the bicycle frame. In some embodiments, the frame target 300 may be coupled with the bicycle by coupling the frame mount portion 305 of the frame target 300 with a frame mount portion coupled with the bicycle, as described below in FIG. 4. The frame target 300 may contain one or more dots such as dots A, B, or C. The dots A, B, or C may be asymmetrical or otherwise visually distinct such that an orientation or rotation of the dots from the point of view of a digital camera or other observer may be easily identified. In some embodiments, the portions of the frame target 300 surrounding the dots A, B, or C may be visually distinct, i.e. colored differently or composed of a different material, from the dots A, B, or C. This visual distinction may allow for more consistent identification of the frame dots A, B, or C in an image of the frame target 300. In embodiments, at least one of dots A, B, or C may be positioned closer or further than the other dots from the user device when viewed from perspective. Having at least one of the dots A, B, or C closer or farther from the others may increase the accuracy of the rotational pose solution of the frame target 300 as discussed above.

As shown in FIG. 3, the frame mount portion 305 of the frame target 300 may have a hollow portion containing one or more projections such as projection 310. FIG. 4 depicts a frame mount 400. A face of the frame mount 400 may have one or more indents 405 configured to couple with the indents 310 of the frame target 300. The side 410 of the frame mount 400 opposite the indents 405 may be configured to couple with the bicycle. Specifically, the frame mount 400 may be configured to act as a skewer nut and couple to a skewer of the bicycle that holds the cassette 235 to the frame 200.

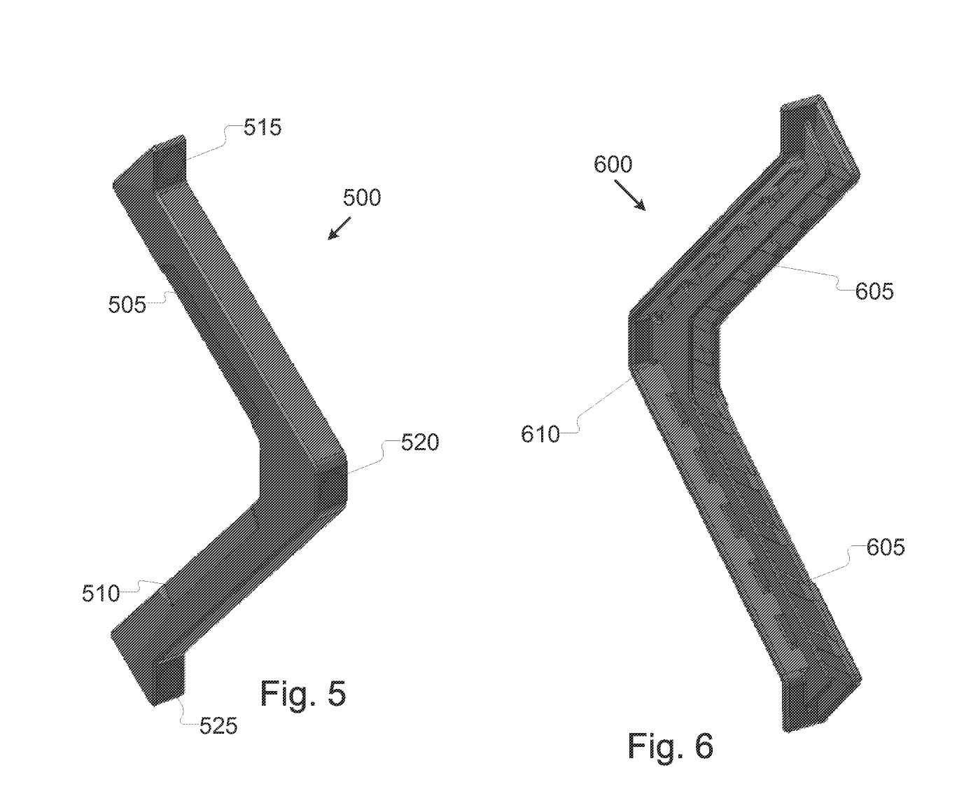

FIG. 5 depicts an example of a cassette target 500 which may be used with the application of the present disclosure. The cassette target 500 may be similar to cassette target 240 of FIG. 2. In embodiments, the cassette target 500 may comprise a first arm 505 and a second arm 510, while in other embodiments the cassette target 500 may have more or less arms, or may have a generally different form factor. The cassette target 500 may include first, second, and third dots 515, 520, and 525. In embodiments, the first, second, and third dots 515, 520, and 525 may not be linear with one another, but instead at least one of the dots may be offset from the other two dots for reasons explained in further detail below. In embodiments the dots 515, 520, or 525 may be visually similar to dots A, B, or C as described above, or may have different visual characteristics.

As depicted in FIG. 2, in some embodiments the cassette target 240 may be coupled with a cassette 235 of the bicycle. As shown in FIG. 6, in some embodiments the cassette target 600, which may be similar to cassette target 500, may include a plurality of spring members 610 in a rear portion of the cassette target 600 opposite the dots 515, 520, or 525. The spring members 610 may be configured to align with a sprocket of the cassette 235 and exert pressure against the sprocket. The cassette target 600 may further include a rigid brace 605 against which the spring members 610 may exert pressure. The pressure of the spring members 610 against the rigid brace 605 may serve to couple the cassette target 600 to the cassette 235 of the bicycle.

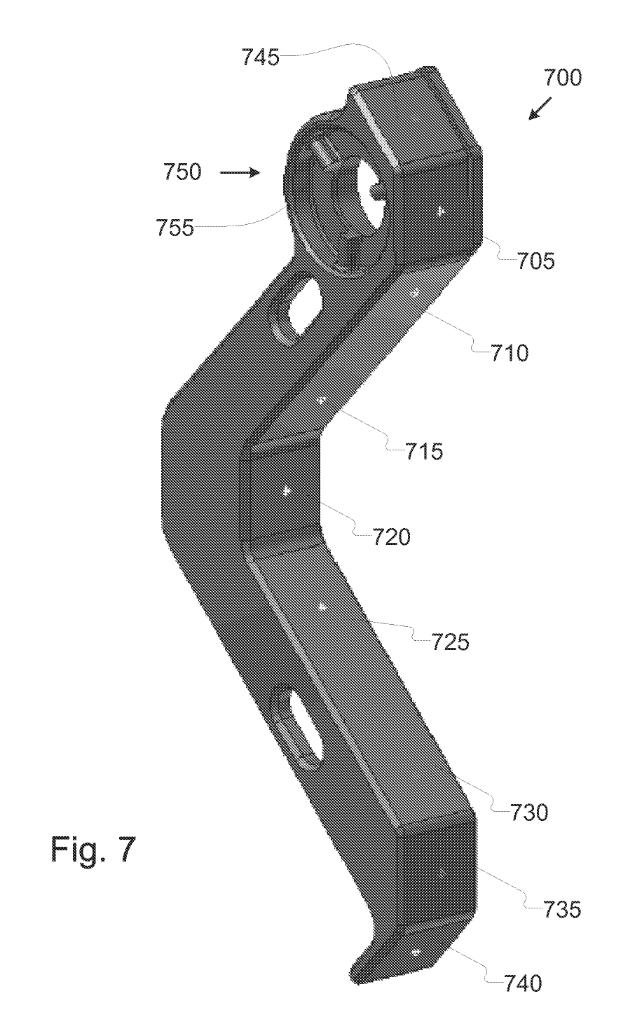

FIG. 7 depicts a view of a derailleur target 700, which may be similar to derailleur target 220 of FIG. 7. The derailleur target 700 may include a plurality of dots such as dots 705, 710, 715, 720, 725, 730, 735, 740, or 745 positioned on different faces of the derailleur target 700. For example, dots 710 and 715 may be at different locations of the same face of the derailleur target 700, and in some embodiments may face a different direction than another dot such as dots 720 or 740. In some embodiments, the dots may be similar to dots A, B, or C of FIG. 3. In some embodiments, it may be desirable for the derailleur target 700 to have a relatively higher number of dots as compared to, for example, the frame target 300 because the derailleur target 700 may rotate as the rear derailleur 205 moves. Therefore, the angle of the derailleur target 700 may change with respect to the digital camera. A relatively larger number of dots on the derailleur target 700 may provide an increased opportunity for the digital camera to see at least three or more dots so that the pose of the derailleur target 700 may be estimated.

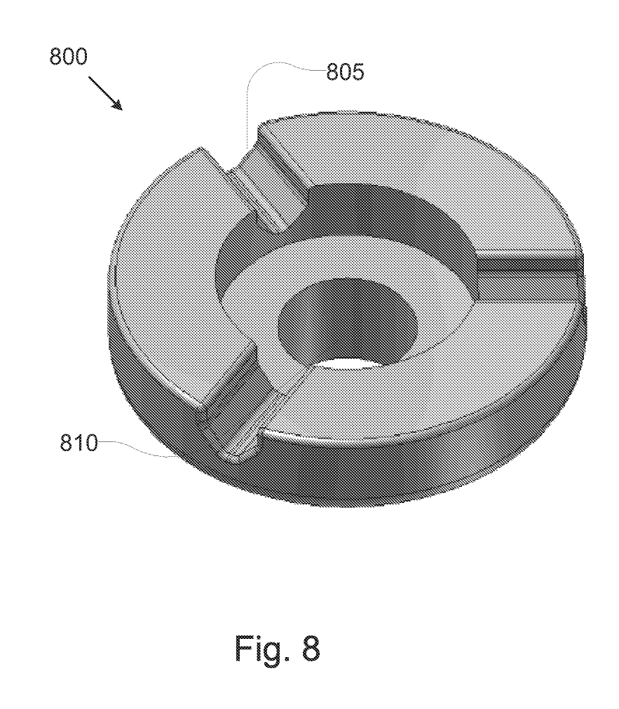

As can be seen, derailleur target 700 may additionally include a derailleur mount portion 750 with one or more projections 755. FIG. 8 depicts a derailleur mount 800 may include a plurality of recesses 805 configured to mate with the projections 755. The derailleur mount 800 may be mated with the rear derailleur 205 for example by a screw or bolt inserted through a central opening 810 of the derailleur mount. In some embodiments the screw may be a screw that passes through one or more gears or pulleys of the rear derailleur 205. In some embodiments the derailleur mount 800 and the derailleur mount portion 750 may be magnetic and configured to magnetically couple with one another. In other embodiments the derailleur target 700 may couple with the rear derailleur 205 by one or more other methods such as tape, zip ties, etc.

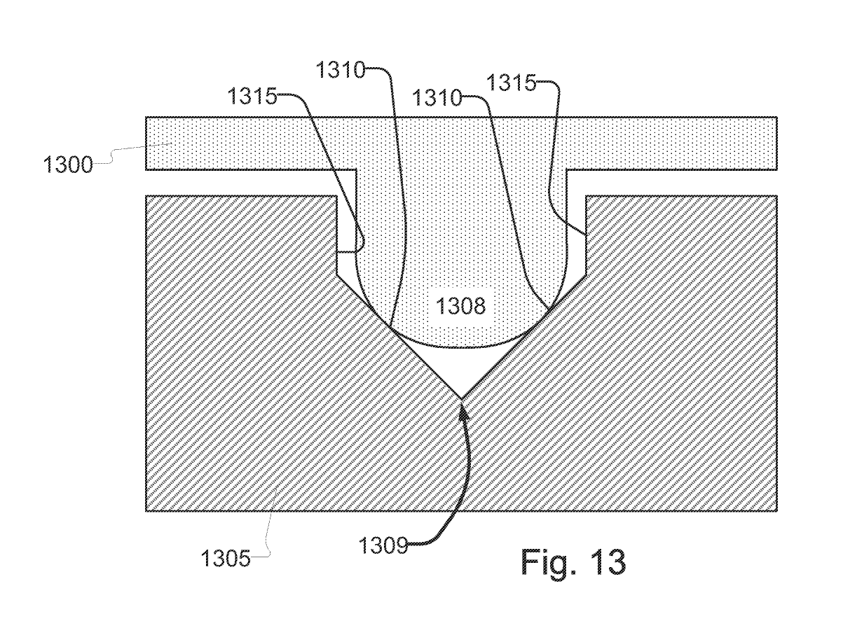

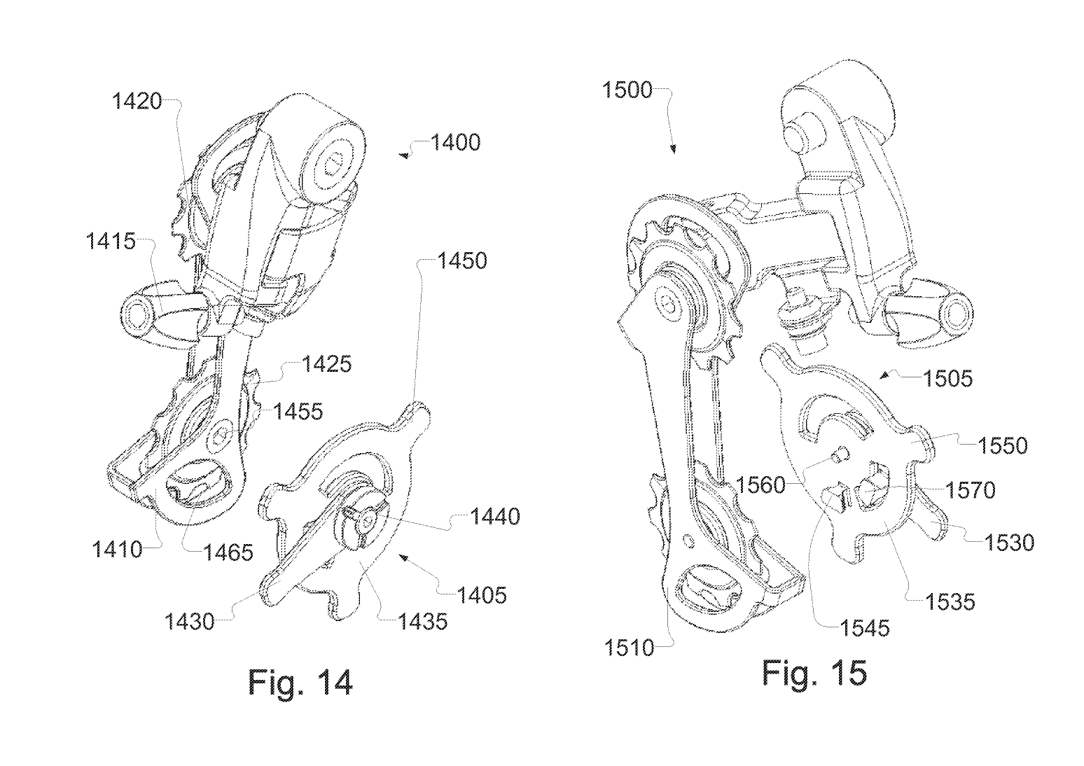

FIG. 14 depicts an alternate derailleur mount 1405 that may be coupled to a rear derailleur 1400. In some embodiments, the rear derailleur 1400 may be similar to rear derailleur 205 of FIG. 2. The rear derailleur 1400 may include a barrel nut 1415, idler pulley 1425, and derailleur cage 1410, which may be similar to barrel nut 215, idler pulley 225, and derailleur cage 210, respectively. The rear derailleur 1400 may also include a jockey pulley 1420. In some embodiments the idler pulley 1425 may be coupled to the derailleur cage 1410 via a derailleur arm screw 1455 with a hole as shown in FIG. 14. Specifically, the hole in the derailleur arm screw 1455 may be configured to couple with a screwdriver, an allen key, or some other fastening tool. Additionally, the derailleur cage 1410 may include one or more cutout portions 1465, as shown in FIG. 1400.

The derailleur mount 1405 may include a body 1435 with one or more protrusions such as protrusion 1450. The body 1435 may be configured to be relatively narrow and generally coplanar with one or more of the idler pulley 1425, the jockey pulley 1420, or a cassette such as cassette 235. In some embodiments the derailleur mount 1405 may further include a lever arm 1430, as described in further detail in FIG. 15. Finally, the derailleur mount 1405 may include a mount portion 1440 which may be similar, for example, to derailleur mount 800 of FIG. 8.

FIG. 15 depicts an alternative view of a rear derailleur 1500 and a derailleur mount 1505. The rear derailleur 1500 may be similar to rear derailleur 1400 and include a derailleur cage 1510 which may be similar to derailleur cage 1410. Additionally, the derailleur mount 1505 may be similar to derailleur mount 1405 and include a body 1535 with one or more protrusions 1550 as well as a lever arm 1530 which may be similar to body 1435, protrusion(s) 1450, and lever arm 1430, respectively. In embodiments, the body 1535 may include a first wedge shaped portion 1545. The lever arm 1530 may be coupled with a second wedge shaped portion 1570. The derailleur mount 1505 may further include a pin 1560 which may, for example, couple the mount portion 1440 to the body 1435.

Operation of the derailleur mounts 1405 and 1505 is best explained with reference to both FIGS. 14 and 15 so that certain features that are clearer in one view than the other may be discussed. In operation, the derailleur mount 1505 may be situated adjacent to the rear derailleur 1500. Specifically, the derailleur mount 1505 may be situated such that the pin 1560 is inserted into the hole of the derailleur arm screw 1455. Additionally, the first wedge shaped portion 1545 may be situated either in, or on one side, of the cutout portion 1465. The other wedge shaped portion 1570 may be positioned on the opposite side of the cutout portion 1465 from the first wedge shaped portion 1545. For example, if the first wedge shaped portion 1545 is within the cutout portion 1465, then the second wedge shaped portion 1570 may be outside of the cutout portion 1465, or vice versa. In some embodiments both the first wedge shaped portion 1545 and the second wedge shaped portion 1570 may be either within the cutout portion 1465, or they may both be outside of the cutout portion 1465.

After the derailleur mount 1505 is positioned, the lever may be actuated such that the wedge shaped portion 1570 moves with respect to the pin 1560. By moving the wedge shaped portion 1570, the two wedge shaped portions 1545 and 1570 may either grip the derailleur cage 1510, or press against the outer sides of the cutout portion 1465. The pressure of the wedge shaped portions 1545 and 1570 against the derailleur cage 1510 may hold the derailleur mount 1505 against the rear derailleur 1500. It will be understood that the term “wedge shaped” is used to describe the wedge shaped portions 1545 and 1570, but such term is not intended to limit the shape of elements 1545 and 1570. In other embodiments, the portions 1545 and/or 1570 may be rounded, rectangular, or some other shape. In some embodiments the portions 1545 and/or 1570 may be constructed of a relatively stiff material such as a plastic or thermoplastic, or a relatively soft material such as a soft foam.

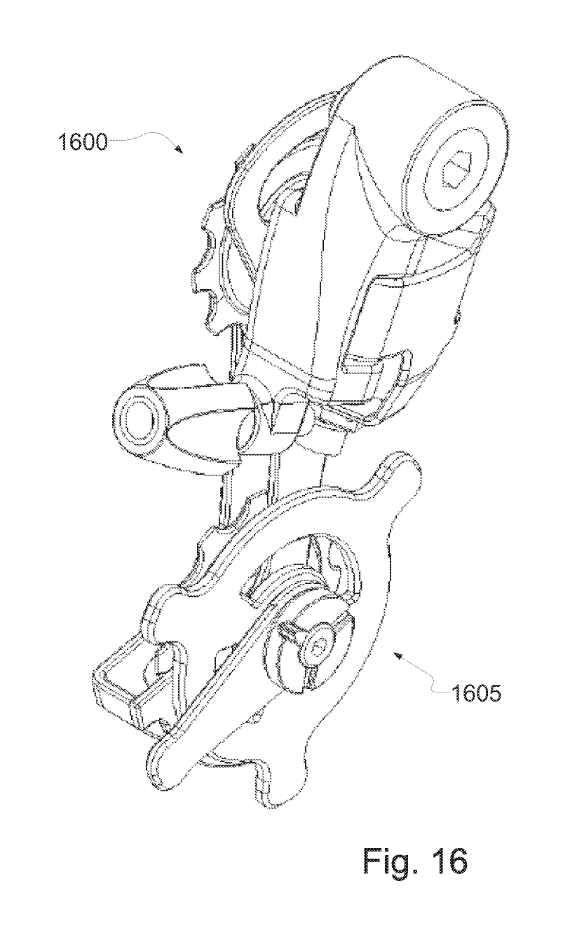

FIG. 16 depicts an example of a derailleur mount 1605, which may be similar to derailleur mounts 1405 or 1505, coupled with a rear derailleur 1600, which may be similar to derailleur mounts 1400 or 1500.

FIG. 13 depicts an example view of a target 1300 coupled with a mount 1305. In some embodiments the target 1300 may be similar to a target such as the derailleur target 700, frame target 300, or some other target. The target 1300 may include a projection 1308 which may be similar to projections 310 or 755. The mount 1305 may be similar to derailleur mounts 800, 1405, 1505, or 1605, frame mount 400, or some other mount. The mount 1305 may have an indent 1309 which may be similar to indents 405 or 805.

In some embodiments the indent 1309 may include a vertical feature such as vertical wall 1315. Additionally, when the projection 1308 is within the indent 1309, for example as shown in FIG. 13, the indent 1309 may only contact the mount 1305 as designated by element 1310.

The above described features of target 1300 and mount 1305 may provide at least two advantages. First, if the target 1300 is coupled via mount 1305 to a derailleur such as rear derailleur 205, the shifting of the rear derailleur 205 from one sprocket of cassette 235 to another sprocket may be sudden and cause significant jarring to the target 1300. However, the vertical walls 1315 of the mount 1305 may help to hold the projection 1308 in place within the indent 1309. Additionally, the fact that the projection 1308 and mount 1305 may be designed such that the projection 1308 only contacts the mount 1305 at two places 1310 may be considered a “kinematic mount” feature and ensure that the projection 1308 is precisely aligned within the indent 1309.

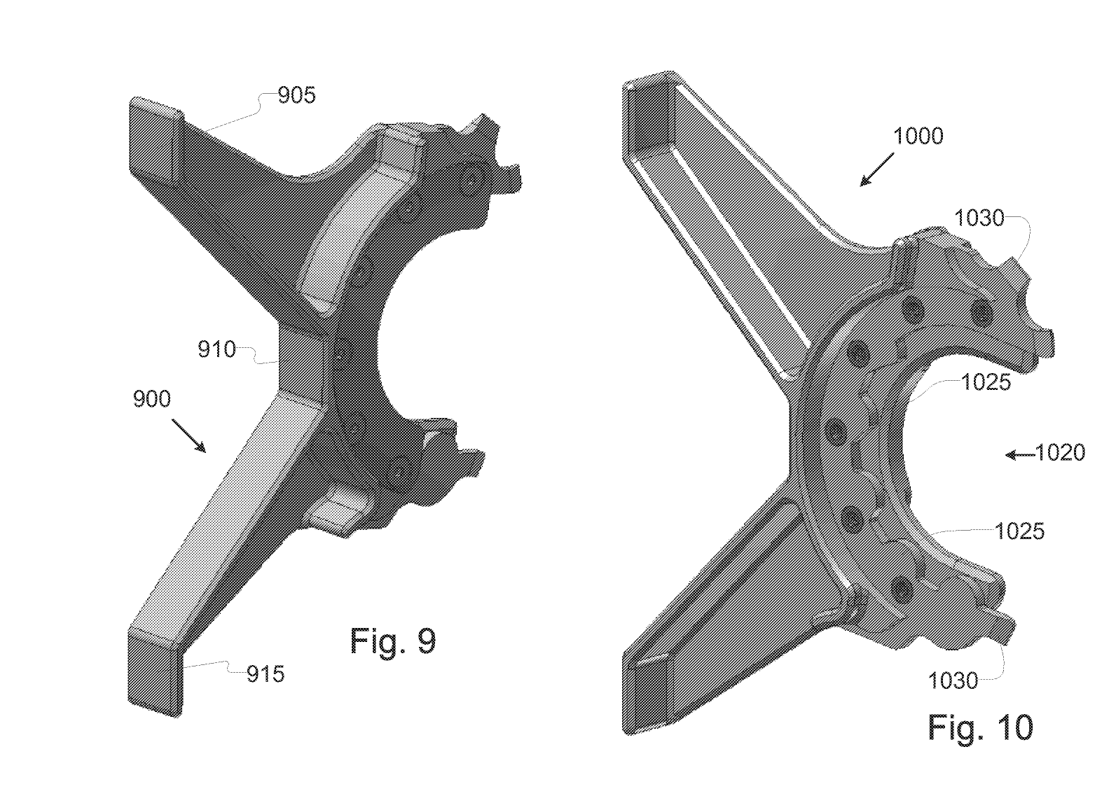

FIG. 9 depicts a view of a front side of a jockey target 900, which may be similar to jockey target 230. The jockey target 900 may include three dots, 905, 910, or 915, which may be similar to dots A, B, or C. FIG. 10 depicts a view of a rear side of a jockey target 1000, which may be similar to jockey target 900. The jockey target 1000 may include a generally c-shaped opening 1020 configured to mate with a jockey pulley (not shown) of the rear derailleur 205. Specifically, the c-shaped opening 1020 may include one or more gear-shaped rounds 1025 configured to mate with the indents of the jockey pulley. The jockey target 1000 may further include chain coupling elements 1030 configured to engage the bicycle chain to help hold the jockey target 1000 in position. In some embodiments the jockey target 1000 may be positioned on the jockey pulley of the rear derailleur 205 by pushing the jockey target 1000 onto the pulley and allowing the chain to snap over the coupling elements 1030. Pushing the target 1000 onto the jockey pulley of the rear derailleur 205 may result in the jockey pulley rotating as the indents of the jockey pulley may engage the gear-shaped rounds 1025. In some embodiments the chain coupling elements 1030 may further engage with the bicycle chain under tension to pull and retain the jockey target 1000 on the jockey target, registering the gear-shaped rounds 1025 to the indents of the jockey pulley.

In embodiments, the processes such as the Quick tune or Full tune processes described above may determine a 3D “pose” from a 2D image of the targets such as targets 225, 220, 230, or 240. Specifically, a computing device such as a smart phone, a tablet, a personal digital assistant (PDA), a computer, or some other computing device, and more specifically a lens of a camera integrated with or coupled with the computing device, may be calibrated to remove distortion (projection error) of the lens. An image of the bicycle with one or more of the various targets may then be taken using the computing device. The location of each of the dots in the 2D image taken by the computing device may be evaluated. Specifically, each target and/or dot may have a unique identifying marking. The mark may also be used to identify a general region to search for second or third dots. After the dots of each target are identified, then the xy position of one, some, or all of the dots and targets may be organized into a matrix for processing. The 3D position of each of the dots may be calculated (as described later). The pose of each target may be used to locate each component, e.g. derailleur 205, cassette 235, frame 200, etc., that a target has been attached to. These positions may be updated by taking additional images. The offset of the derailleur to the cassette, and specifically the derailleur sprocket to the cassette sprocket, may be calculated based on the additional images. The required mechanical adjustment may then be calculated to minimize this offset, and instructions to make the calculated adjustment may be presented to the user as described above with respect to the Quick tune process and Full tune processes.

In embodiments, it may be more desirable to perform a Quick tune or Full tune process when the plane defined by the derailleur sprocket is parallel, or approximately parallel, and has zero or close to zero offset with the plane defined by the desired cassette sprocket at each index shift point. Additionally, the parallax of the computing device may make it difficult to simply determine a derailleur adjustment based on an XY image. By using targets with three dots that are offset from one another, the position of the targets in 3D space, i.e. the “pose” of the targets, may be calculated, and the skew which may result from the image parallax may be compensated for. This parallax compensation may allow the computing device to be positioned closer to the targets and hand held, in other words, the computing device may be pointed toward the targets with a wider degree of freedom.

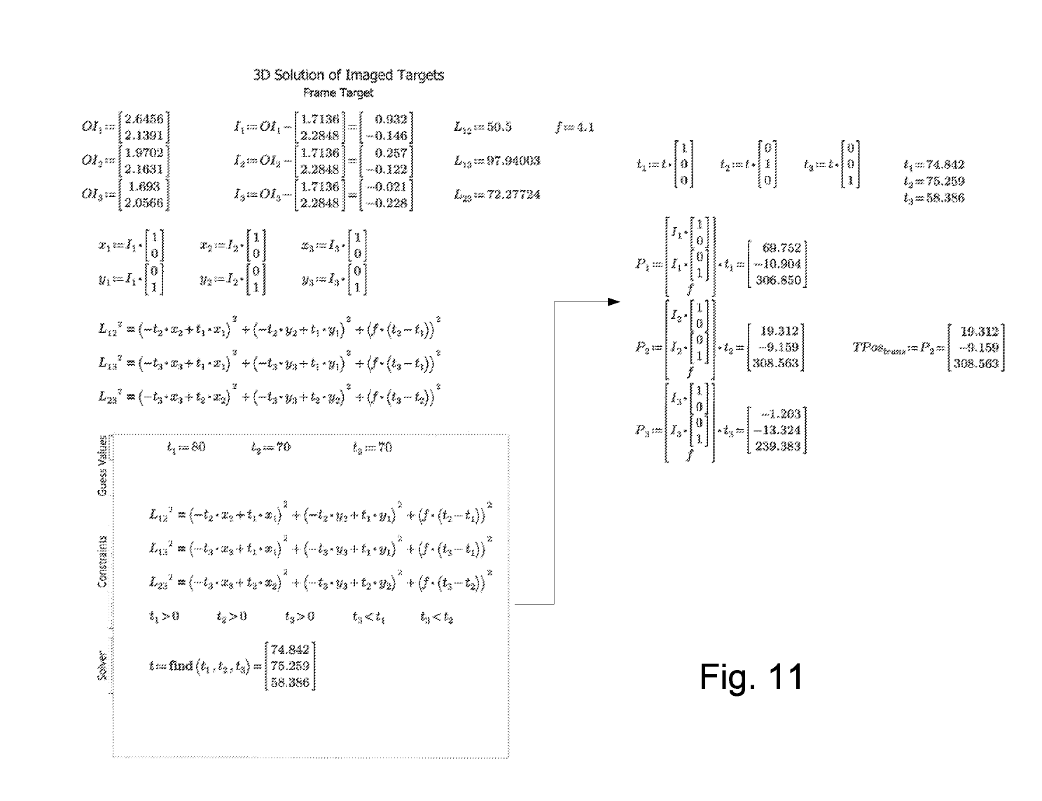

FIG. 11 depicts an example pose calculation which may be accomplished using measurements taken from a single image for a bicycle with a frame target, derailleur target, and cassette target such as those shown in FIG. 2. In this particular example, the values may be scaled to that of the camera of the computing device in millimeters. As inputs, the application may identify the values for OI₁, OI₂, OI₃, L₁₂, L₁₃, and L₂₃ for each target (assuming the target includes three dots). In other embodiments, more or less dots or values may be identified or used. In embodiments, OI₁ may be the identified XY values of a first dot of a target. OI₂ may be the identified XY values of a second dot of the same target. OI₃ may be the identified XY values of a third dot of the same target. The L values, for example L₁₂ may be the length or distance between two dots of the target, e.g. the first and second dots. In embodiments, these L values may be input by the user into the computing device, and/or pre-programmed into the application based on the target used. In other embodiments, they may be identified according to a calibration process, as described later. f may be the focal length of the camera of the user device. Although not precisely identified in FIG. 11, the additional values used in the determination of I₁, I₂, and I₃, depicted in FIG. 11 as the values 1.7136 and 2.2848, may be determined values of the “center” of the image defined along with f during a calibration process, and used as a basis for determining relative distances of one or more of the dots from the “center” of the image. The values in FIG. 11 may be depicted in millimeters, or may be scaled according to some other scale.

After identifying the various input values in FIG. 11, the 3D values P₁, P₂, and P₃ may be identified, which may respectively represent the 3D position of the first dot, second dot, and third dot. After this pose determination is performed for each target and/or dot in the image, then the relative positions of one or more components of the bicycle attached to a target, e.g. the frame, derailleur, and/or cassette, may be identified.

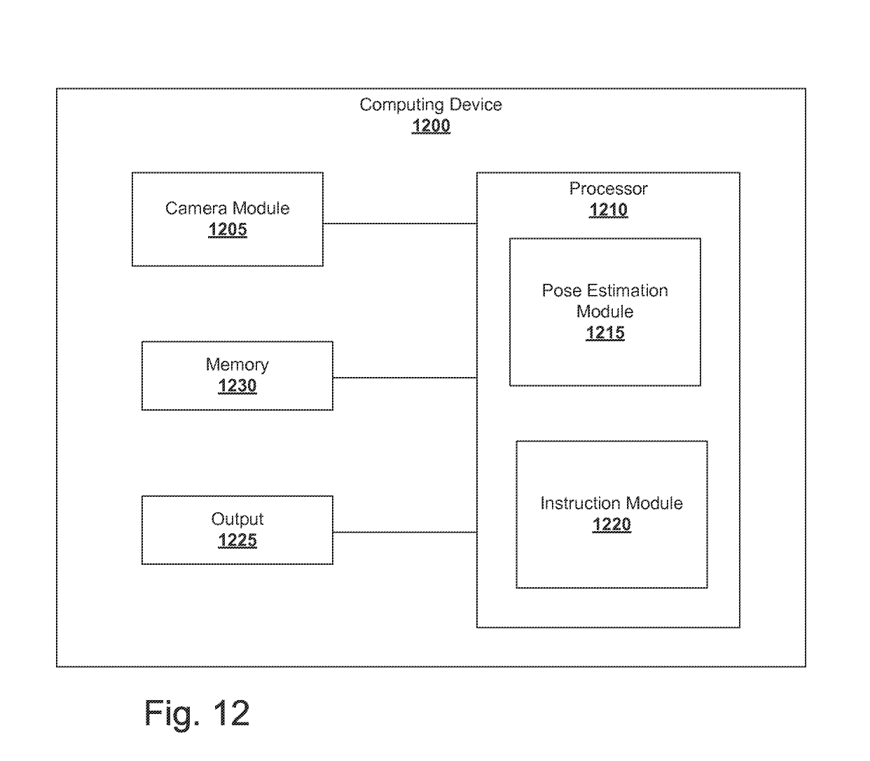

FIG. 12 depicts an example of a computing device 1200. In embodiments, the computing device 1200 may be configured to perform the Quick tune and/or Full tune processes described above. In some embodiments the computing device 1200 may include a camera module 1205. The camera module 1205 may be, or be coupled with, a digital camera configured to take one or more still or moving images of the targets described above.

In some embodiments, the computing device may include a processor 1210 coupled with the camera module 1205. The processor 1210 may include a pose estimation module 1215 and an instruction module 1220. The processor 1210 may be configured to perform one or more of the elements of the Quick tune or Full tune processes described above. For example, the processor may be configured to move from state to state as the process progresses. In embodiments, the pose estimation module 1215 may be configured to identify a pose of one or more of the targets, as described above. Additionally, the instruction module 1220 may be configured to identify and/or provide an instruction to the user based on the current state or inputs received by the processor 1210 from the camera module 1205. Specifically, the instruction module 1220 may be coupled with and configured to provide an instruction to the user using output 1225, which may be a visual display, a speaker, haptic feedback, or some other type of output.

In some embodiments, the processor 1210 may be coupled with a memory 1230 configured to store computer instructions related to the pose estimation, the Quick tune process, the Full tune process, or some other computer instructions. In some embodiments the memory 1230 may be removable memory such as a USB drive or a flash drive. In some embodiments the memory may be non-volatile memory, while in other embodiments the memory may be volatile memory. For example, the memory 1230 may be or include dynamic random access memory (DRAM), read only memory (ROM), or some other type of memory.

It will be understood that computing device 1200 depicts only one configuration of a possible computing device, and in other embodiments the computing device 1200 may be configured differently. For example, in other embodiments the pose estimation module 1215 and/or instruction module 1220 may be separate from the processor. Specifically, in some embodiments the instruction module 1220 may be a part of or otherwise coupled with the output 1225. Additionally, in some embodiments one or all of the camera module 1205, output 1225, or memory 1230 may be separate from the computing device 1200.

As described above, there are several variations of target configurations that may be used with the current application in different embodiments. Additionally, the present disclosure may be used not only to calibrate a derailleur of a bicycle, but also to determine whether components are worn are damaged. Although several components are described above as having, e.g. a single dot or a plurality of dots, other embodiments may have dots of different number, shapes, or sizes. Similarly, although the above embodiments are described with respect to calibrating a rear derailleur to a rear cassette of a bicycle, the processes may easily be adapted in other embodiments for the calibration of other components such as a front derailleur, a stem, a handlebar configuration, shifter configurations, brake configurations, cleat positioning, general bicycle setup, or any other bicycle component, each of which may have additional or alternative targets.

Additionally, the processes discussed above are described with reference to a bicycle, but may be easily applied to other mechanical systems used in industries such as:
Automotive repair
Production assembly requiring precision alignment
Construction
In situ satellite repair
Guiding airplanes into terminals
Satellite dish alignment
Gem cutting
Wheel alignment
Harbor pilot guidance
In situ machine calibration

What is claimed is:

1. One or more non-transitory computer readable media comprising instructions configured to cause a computing device, upon execution of the instructions by one or more processors of the computing device, to:
determine, based at least in part on an image, a pose of a first target coupled with a first component of a mechanical system and a pose of a second target coupled with the mechanical system;
identify, based at least in part on the pose of the first target and the pose of the second target, an adjustment to at least the first component; and
provide an instruction to a user to adjust the first component, the instruction based at least in part on the identified adjustment.

2. The one or more non-transitory computer readable media of claim 1, wherein the mechanical system is a bicycle.

3. The one or more non-transitory computer readable media of claim 2, wherein the first component is a bicycle frame, a bicycle derailleur, a bicycle shifter, or a bicycle cassette.

4. The one or more non-transitory computer readable media of claim 1, wherein the pose of the first target is related to a position and orientation of the first target in three-dimensional space.

5. The one or more non-transitory computer readable media of claim 1, further comprising instructions to capture the image.

6. The one or more non-transitory computer readable media of claim 1, wherein the computing device is a smart phone.

7. The one or more non-transitory computer readable media of claim 1, wherein the pose of the first target is a first pose of the first target, the pose of the second target is a second pose of the second target, the instruction is a first instruction, the adjustment is a first adjustment, and the image is a first image, and further comprising instructions to:
determine, based at least in part on a second image captured after the first instruction is provided to the user, a second pose of the first target and a second pose of the second target;
identify, based at least in part on the second pose of the first target and the second pose of the second target, a second adjustment to at least the first component; and
provide a second instruction to a user to adjust the first component, the instruction based at least in part on the identified second adjustment.

8. A method comprising:
capturing, by a computing device, an XY image of a target including a plurality of dots, the target coupled with a component of a mechanical system;
determining, by the computer device, a location of each dot in the plurality of dots in the XY image;
calculating, by the computer device, a three-dimensional (3D) pose of the target based at least in part on the location of each dot in the XY image;
identifying, by the computer device, an adjustment to the component based at least in part on the pose of the target; and
providing, by the computer device, an instruction related to the adjustment to a user of the computing device.

9. The method of claim 8, wherein the mechanical system is a bicycle.

10. The method of claim 9, wherein the component is a bicycle derailleur or a bicycle shifter.

11. The method of claim 8, wherein the computing device is a smart phone.

12. The method of claim 8, wherein the XY image is a first XY image and the adjustment is a first adjustment, and further comprising:
capturing, by the computing device after the providing the instruction, a second XY image of the target; and
identifying, by the computer device, a second adjustment to the component based at least in part on the second XY image.

13. An apparatus comprising:
a camera module to capture an image of a target coupled with a component of a mechanical system, the target comprising a plurality of dots;
a pose estimation module coupled with the camera module, the pose estimation module to determine, based at least in part on the dots, a three dimensional pose of the first target; and
an instruction module coupled with the pose estimation module, the instruction module to:
identify, based at least in part on the three dimensional pose, an adjustment to the component; and
provide an instruction to a user to adjust the component, the instruction based at least in part on the identified adjustment.

14. The apparatus of claim 13, wherein the apparatus is physically separate from the mechanical system.

15. The apparatus of claim 13, wherein the mechanical system is a bicycle.

16. The apparatus of claim 15, wherein the component is a bicycle derailleur or a bicycle shifter.

17. The apparatus of claim 13, wherein the three-dimensional pose of the target is related to a position of the target in three-dimensional space relative to another target coupled with the mechanical system.

18. The apparatus of claim 13, wherein the apparatus is a smart phone.

19. The apparatus of claim 13, wherein the image is a first image and the pose is a first pose, and the camera module is further to capture a second image of the target after the provision of the instructions to the user by the instruction module; and
the pose estimation module is further to determine a second pose of the target based at least in part on the second image.
